(19) United States
(12) Patent Application Publication
(10) Pub. No.: US 2015/0135921 A1
(43) Pub. Date: May 21, 2015

(54) Continuous Tortilla Chip Cutter

(71) Applicant: Casa Herrera, Inc., Pomona, CA (US)

(72) Inventor: Jose de la Luz Martinez-Montes, Huntington Park, CA (US)

(73) Assignee: Casa Herrera, Inc.

(21) Appl. No.: 14/465,624

(22) Filed: Aug. 21, 2014

Related U.S. Application Data
(60) Provisional application No. 61/868,455, filed on Aug. 21, 2013.

(51) Int. Cl. B26D 5/28; B26D 7/06; B26D 3/24; A23L 1/164; B26D 1/62

(52) U.S. Cl. CPC B26D 5/28; A23L 1/1645; B26D 1/62; B26D 3/24; B26D 7/0625; A23V 2002/00
USPC 83/156; 83/370; 83/365

(57) ABSTRACT

A continuous tortilla chip cutting system where tortilla carried on a conveyor are continuously divided by a cutting mechanism into pre-cuts for frying into chips. A programmable controller drives a servo motor that moves an upper surface of the conveyor at a known velocity V, and a detector located above the conveyor at a known distance D from the cutting mechanism alerts the controller to the imminent arrival of the tortilla. The controller also controls a servo motor that actuates the cutting mechanism in a stop/start fashion. Based on the detection of the tortilla, the controller drives the servo motor associated with the cutting mechanism at just the right time and at just the right speed so that the cutter mechanism cuts each arriving tortilla into predictable sub-units called “pre-cuts” based on the velocity V of the conveyor belt, the detection of the flat bread unit carried by the conveyor, and the known distance between the moving flat bread unit and the cutter assembly.

### BACKGROUND OF THE INVENTION

1. Field of the Invention

This application relates generally to assembly line food production machinery and, more particularly, to a continuous tortilla chip cutter used, for example, for cutting tortilla chips from whole tortillas.

2. Description of the Related Art

FIGS. 1 to 5 show a flatbread unit 20 (i.e. a tortilla, pita bread, etc.), or a stack thereof, being processed into “pre-cuts” 21 that will be fried and served. Restaurants and families alike have long been using a knife to hand-cut corn tortillas to make old fashioned fresh-fried tortilla chips. The hand-cut method works by using a knife to cut a tortilla 20, or short stack of tortillas (e.g. 5-7), into chip-shaped pieces 21 and then frying those pieces in hot oil. FIG. 1 shows a traditional tortilla cut that forms substantially-rectangular chips. FIG. 2 shows more closely spaced cuts that form thin strips that are suitable for tortilla soup. If done by hand, the cook would use a knife to make the parallel cuts, and then make a final perpendicular cut that divides the parallel strips into two groups.

Hand-cutting is sometimes used to make triangular chips by using a knife to cross-cut the tortilla stack into four, six, or more pieces, as shown in FIGS. 2 to 5, but when cutting the tortilla into six or more pieces, which requires three or more cuts, it is somewhat difficult to get all of the cuts to go through a common center. It can be done, but it is a relatively laborious process and the result is substantially imperfect chips.

In the snack food industry, manufacturers usually make production-line chips that are for sale to retail consumers by sheeting raw corn masa (or other dough) into a continuous dough sheet, cutting chip shaped dough pieces from the sheet, baking the dough pieces in an oven, frying the baked dough pieces in hot oil, cooling the fried chips, and then packaging the chips in retail bags for distribution. The cutting of chip-shaped pieces from a raw sheet of dough usually leaves a thickened border or “hem” on the uncooked, chip-shaped dough piece, and on the final product. The chips are consumed at room temperature sometime over the next several days or weeks. The chips made in this manner are ideal for sale in grocery stores, convenience stores, vending machines, and the like, but are less than ideal for restaurant use.

Sheeted chips can be produced in mass quantities, but it is usually impractical to serve them fresh fried. Moreover, sheeted chis inherently have a relatively thick “hem” around the perimeter of the chip shapes due to the masa that is pushed aside by the cutting blades of the cutter roller. Because of the hem, many consumers place a premium on the higher-quality of tortilla chips that are made by starting with fully-cooked (baked) corn tortillas, cutting the tortillas into chip shaped pre-cuts (e.g. by hand, or by cutting stacks of tortillas with suitable machines called choppers), and then frying the pre-cuts. Restaurants prefer pre-cuts because they are fresh fried and promptly served. When compared with fresh fried chips, sheeted, pre-packaged chips have a thickened border, are not served warm, and have a different taste and texture.

Some restaurants that serve fresh-fried tortilla strips prefer to buy boxes of ready-to-fry pre-cuts so that they can fresh-fly chips, on site and on demand, without having to hand-cut the tortillas. This approach is consistent with the higher volume demand of certain restaurants. There may also be a market for retail packaged chips that are made by frying pre-cuts and packaging them for retail sale.

Tortilla factories have been serving their commercial restaurant customers by taking the same cooked tortillas that they might otherwise package and sell as whole tortillas, and cutting them into so-called “pre-cuts” 21 for delivery to the restaurant in suitable boxes for later, on demand frying at the restaurant. Typically, a factory making pre-cuts operates by cooking the tortillas in a normal manner, and then proceeds by aligning a number of them into a stack, and by cutting the stack to create the pre-cuts 21. Some machines operate by pushing the stack through one or more stationary cutting blades. Others operate by pushing one or more cutting blades through a stationary stack of tortillas. In either case, a single complex cutting blade may be used (e.g. an X-shaped blade), or a single blade may be used and the blade or stack of tortillas is rotated between cuts.

The conventional approach to making pre-cuts requires many steps that are spread over many hours, sometimes as many as 24 hours, for example

1. Make the raw tortillas (prepare the masa by cooking raw corn or mixing water with corn flour and then sheet the masa into a sheet and cut tortilla shapes from the sheet)

2. Cook (bake)

3. Cool

4. Count

5. Stack by hand (e.g. on racks or in boxes)

6. Store them to cool (maybe overnight) so that they stick together less when cut

7. Cut pre-cuts from the stacks by manually placing the stacks on a cutter (with some requiring hand rotation)

8. Convey the pre-cuts

9. Tumble the pre-cuts (to separate the many pre-cuts that are stuck together)

10. Weigh

11. Box

12. Deliver to restaurants

The prior art contains numerous tortilla cutters that are suitable for cutting pre-cuts from a stack of tortillas (step 7 above), but they exhibit certain deficiencies that are addressed by the present invention.

U.S. Pat. No. 6,318,225, entitled Tortilla Cutter, invented by Longoria, describes an automatic tortilla cutter that uses a piston-driven cutter that is formed from two vertically-oriented blades that arranged in an X-configuration. In operation, an operator manually loads a stack of tortillas below the X-shaped cutter, and then the apparatus drives the X-shaped cutter down through the stack. This cutter requires the extensive manual labor and prevents full automation, a key characteristic that food production businesses aim to achieve.

U.S. Pat. No. 5,148,655, entitled Slicer and Bagger for Substantially Flat Food Products, invented by Salinas, shows a stack of of food products manually placed on top of an X-shaped slicing blade. When pressed downward by a ram member, the food products are divided into smaller segments that fall into a bag located below the blade. At least one drawback of this device is its complexity and its inapplicability to a continuous and automated cutting operation.

U.S. Pat. No. 4,978,548, entitled Method and Apparatus for Continuous

Production of Tortilla Chips, invented by Cope et al., describes a method for producing tortilla chips where a stack of tortilla shapes is refrigerated before being pushed through the knife blades of a chip cutter.

Shortcoming of the Prior Art Cutters

Many different kinds of machines have been designed to make tortilla chips from whole tortillas. The task generally involves three successive operations: (1) stacking tortillas vertically, one on top of another; (2) cutting through the tortillas with a vertical blade making a motion downward and through the stack of tortillas; and (3) separating the chopped tortillas from each other through an industrial tumbling dryer.

When the task of cutting whole tortillas into tortilla chips is used as described above, the machine is sometimes known as a “tortilla chip chopper” or simply a “chopper.” When the process is performed using the system as described below (as the exemplary tortilla production environment), the system is usually known as a continuous tortilla chip cutter. Regardless of the method, both systems are part of a much larger food production system of producing tortilla chips and packaging them for further processing or consumption.

That being said, the ultimate goal of a chopper/continuous tortilla chip system is to cut tortillas chips from whole tortillas to create a tortilla chip without a “hem.” A hem is a thick notch at the point of cutting that provides additional structural reinforcement to the chip, creating a harder and “stronger” chip. The benefit of creating a chip without a hem is that the chip is more tender and fragile. As a result, the fragile chip does not require as much pressure or effort to chew (because it breaks inside the end user's mouth more easily) and is less likely to cause oral lacerations. An additional benefit is that tortilla chips made through this method, without a “hem,” represent more authentic or old fashioned chips where restaurants would cut day-old-tortillas, fry them, and serve them to their customers. On the other hand, tortilla chips with a hem are preferred “scooping” chips.

Chopping

There are many different types of choppers (also known as slicers or cutters) that have been used for some time. In a high-speed production environment, the traditional method has been to stack tortillas by hand (or using an automated counter/stacker system), place them in a vertical tunnel-like structure, and cut them using a mechanical blade which travels downward through the stacked tortillas. In a typical tortilla chip chopper, the chopper apparatus is a mechanical blade (usually manufactured in an X formation) which chops through a stack of tortillas by forcefully moving downward through the stack of tortillas. In another embodiment, the stack can be placed on top of a fixed, stationary blade (usually manufactured in an X formation) whereas a flat piece of metal pushes the stack of tortillas downward against the blade, slicing the tortillas and pushing the pieces into a compartment below.

Separating/Freeing From Adhesion

At the point of chopping, the tortillas are stacked vertically, one on top of another. Unfortunately, due to the moisture content of the tortillas at the time of chopping (which is usually about 30%), the tortilla pieces “stick” together as the blade applies pressure and these pieces must be freed so that no two chips are “stuck” together. This process is generally known as freeing the chips from adhesion.

Tumbling

That being said, due to the adhesive properties of the tortilla's moisture content, the tortilla chips need to be freed from adhesion and to perform this, an industrial tumble dryer is often employed. The use of an industrial tumble dryer serves two functions: First, the tumbling movement tends to separate the chips from each other; and second, the heat helps to evaporate the moisture content of chips, removing the “stickiness” of the chips. In another embodiment a vibrating conveyor may be used instead of a tumbling conveyor.

The prior art chip cutters operate on a stack of tortillas, in batches. As a result, they generally require the counting and stacking of the tortillas, and they generally require the tortillas to be more fully cooled (or even refrigerated) to reduce sticking caused by the blades compressing the tortillas into one another at the cut lines. Nonetheless, even with extensive cooling, sticking continues to be a problem due to the moisture content of the stacked tortillas and tumblers or shakers are often used to separate the pre-cuts from one another. In addition, many of the prior art systems require manual placement of the stacks. There remains a need, therefore, for a continuous tortilla chip cutting system that improves on the prior art.

### BRIEF DESCRIPTION OF THE DRAWINGS

FIGS. 1 to 5 are, for context, top plan views showing how a tortilla or other flatbread unit 20 may be sliced into pre-cuts 21 of various desired shapes for frying;

FIGS. 6 and 7 are schematic top and side views of a first preferred embodiment of a continuous flat bread cutting apparatus 10 for cutting flat bread units 20 into pre-cuts 21, shown here as comprising a conveyor 40, a detector 50, a generic cutting mechanism 60 that can take on any suitable construction or manner of operation that is consistent with the present invention, a conveyor motor M40, a cutter motor M60, and a controller 70;

FIGS. 8 and 9 are schematic top and side views of a second preferred embodiment of a continuous flat bread cutting apparatus 210 that is similar to the first preferred embodiment, but comprises a cutting mechanism 260 more specifically formed from a pair of counter-rotating rollers 262, 264;

FIG. 10 is a perspective view of the cutting mechanism 260 used in the second preferred embodiment of FIGS. 8 and 9;

FIG. 11 is an isolated perspective view of the rotating die, or cutter roller 264, showing how its blades 265 will divide a tortilla 20 into four triangular pre-cuts 21 if its rotation is timed such that that the central portion 266 is aligned with the center of the tortilla 20 as it passes through the cutting mechanism 260;

FIG. 12 is a dimensioned plan view of the cutter roller 264 showing its general construction;

FIG. 13 is a perspective view of a third preferred embodiment that has two parallel rows or lanes;

FIGS. 14 to 16 are top, input end, and output end views, respectively, of the third preferred two-row embodiment of FIG. 13;

FIG. 17A is a perspective view of a fourth presently preferred continuous flat bread cutting system 410 that features a frame 420 carrying six independently driven conveyors 40;

FIG. 17B is a view of the graphical interface to the preferred controller 70;

FIG. 17C is a screen used to adjust the home positioning that accurately and repeatedly positions the cutter roller 464 in the center of the tortilla 20;

FIG. 17D is a perspective view of the electrical box 415 on the lower exit side of the system 410;

FIG. 18 is a close-up view of the output end of the six conveyors 40, with the protective cover 411 lifted open, to reveal six corresponding sensors 450;

FIG. 19 is a close-up view looking inward toward the sixth or right-most sensor 450 in FIG. 18;

FIG. 20 is a close-up view of the output side of the same row shown in FIG. 19, but looking back in an opposite direction;

FIG. 21 is a view of the output side of the system 410, like FIG. 20, but with the protective cover 412 rotated upward about its hinges in order to reveal more details;

FIG. 22 is a perspective view of a modular cutting mechanism cartridge 460, shown in isolation for clarity of construction and overall operation;

FIG. 23 is a close-up view of the non-geared side the modular cutting mechanism cartridge 460 of FIG. 22, showing the bearings and positional adjustment mechanism;

FIG. 24 is an even closer view of the interface between the aperture 466 in the side plate 461 and the carrier 485 that supports the bearings 484 that hold the cutter roller 464;

FIG. 25 shows how the cutting blades 465 of a cutter roller 464 (here a 6-chip cutter) intersect in a central portion 466 of substantial area;

FIG. 26 is a schematic representation of the cutter roller 464 of FIG. 25, including its cutting blades and central portion 466;

FIG. 27 is a schematic representation of an improved cutter roller 564 where the cutting blades 565 are arranged to be close enough to cut the tortilla 20 into the pre-cuts 21 of desired shape without creating a dense central section as in FIG. 25; and

FIGS. 28 and 29 relate to alternative cutter roller 664 that uniquely cuts several similar shaped pre-cuts 21 from a larger tortilla

### DETAILED DESCRIPTION OF THE PREFERRED EMBODIMENTS

The present invention can reside in many possible embodiments, but the presently preferred embodiments reside in a Continuous Tortilla Chip Cutter that is part of a tortilla chip cutting environment as follows

### Exemplary Tortilla Chip Cutting Environment

In an exemplary tortilla chip cutting environment there are five successive operations: (1) the transportation of the tortillas directly from the cooling conveyor to the Continuous Tortilla Chip Cutter; (2) the acceleration of the tortillas creating distance between tortillas/physical separation; (3) the cutting of the tortilla; (4) discharge; and (5) cooling. Furthermore, as compared to the prior art described above, the exemplary tortilla chip-cutting environment requires less manual labor, provides a safer environment, and requires less energy be consumed.

Transportation. The exemplary tortilla chip cutting environment is one which eliminates the need for counting and stacking and automatically transports the tortillas to the cutter, providing the food production manufacture the ability to become fully automated. From where the tortillas are being cooled, they can be routed to an additional transporting belt leading to the Continuous Tortilla Chip Cutter System. An additional transporting belt is directly attached to the cooling conveyor where tortillas are cooled, allowing the cooled tortillas to be chopped shortly after being produced.

Acceleration. Once the tortillas have been transported, they reach another conveyor belt leading directly to the cutter. This additional conveyor travels at a rate of speed higher than the previous conveyor so that distance (physical space) is created between each of the tortillas. As the tortillas travel upward through the high-speed conveyor they pass through a tunnel-like enclosure which contains a robotic eye. This robotic eye performs a visual inspection that notifies an on-board computer of the tortilla's presence and the length of time before the tortilla reaches the cutter. Moreover, with this robotic eye, the cutting apparatus is activated only at the time the tortilla reaches the cutter.

Cutter/Slicer Mechanism. As previously mentioned, there are many different types of cutters (sometime also known as slicers or choppers) that have been known for used for some time. In a high-speed production environment, the traditional method has been to stack tortillas by hand, place them in a vertical tunnel-like structure, and cut them using a blade which travels downward through the stacked tortillas. However, the continuous tortilla cutter system uses a rotating die (or cutter) that captures each individual tortilla and rotates over the tortilla, cutting it into quarters, eighths, or whatever size a food producer desires. The benefit of this is that each tortilla is cut separately with pieces being ejected from the cutter in a manner where the pieces are not placed on top of each other and pressed together with force. If these pieces were placed on top of each other and sliced with force, the moisture would make them “stick” together and require them to be separated through a tunnel dryer. This cutter/slicer mechanism makes this step (separating the pieces through a tunnel dryer) unnecessary as the pieces are separated at the time of cutting.

Discharge. After the tortillas have been cut to create tortilla chips, the chips are discharged from the cutter to the cooling conveyor belt.

Cooling. An exemplary cooling conveyor belt may be four (4) to eighteen (18) rows in height, allowing chips to begin at the top and make their way down, row-by-row, so that the chips may be cooled and to assist in evaporating any additional moisture prior to packaging. A blower is usually associated with the cooling conveyor belt to blow cool air throughout the belt to ensure temperature cool down.

### First Preferred Embodiment

### General Operation

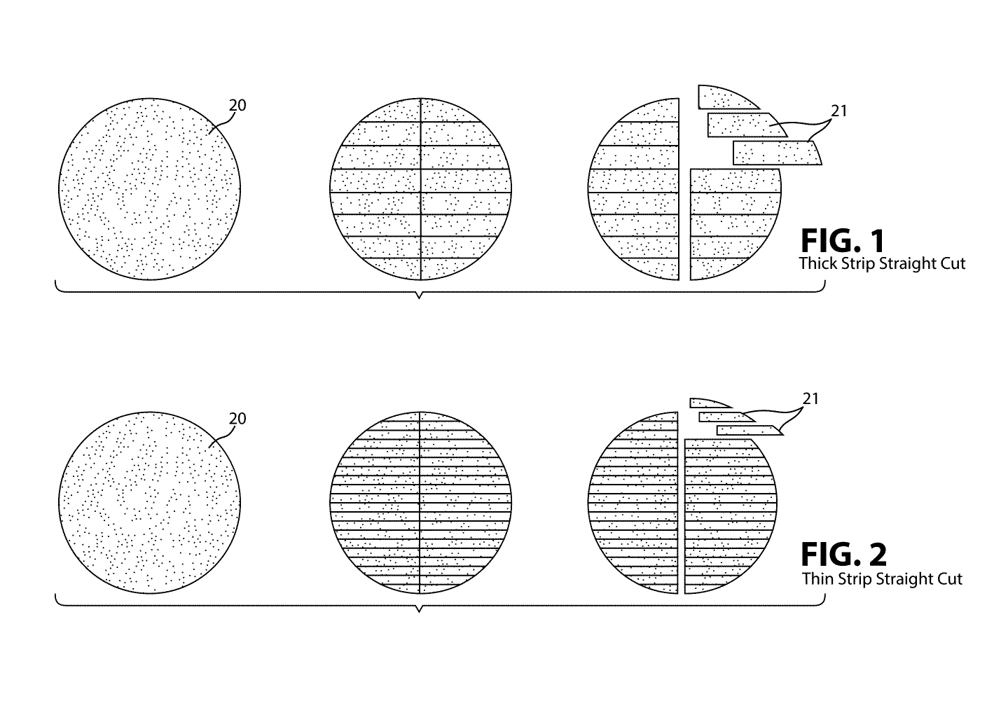

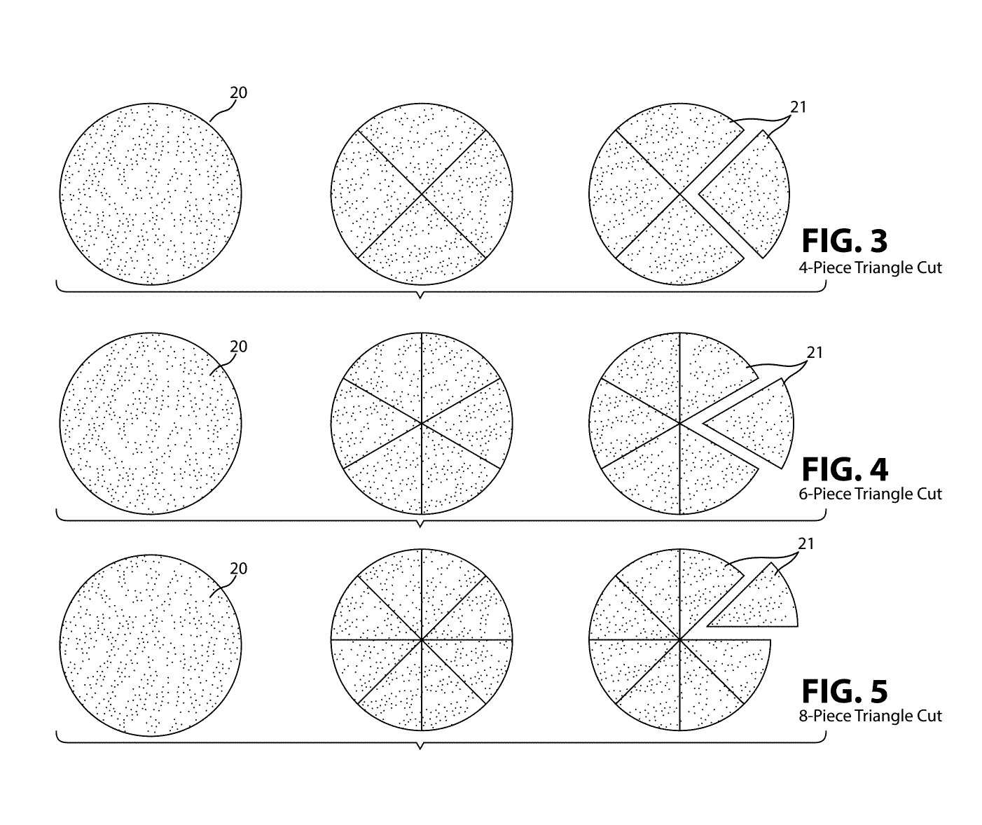

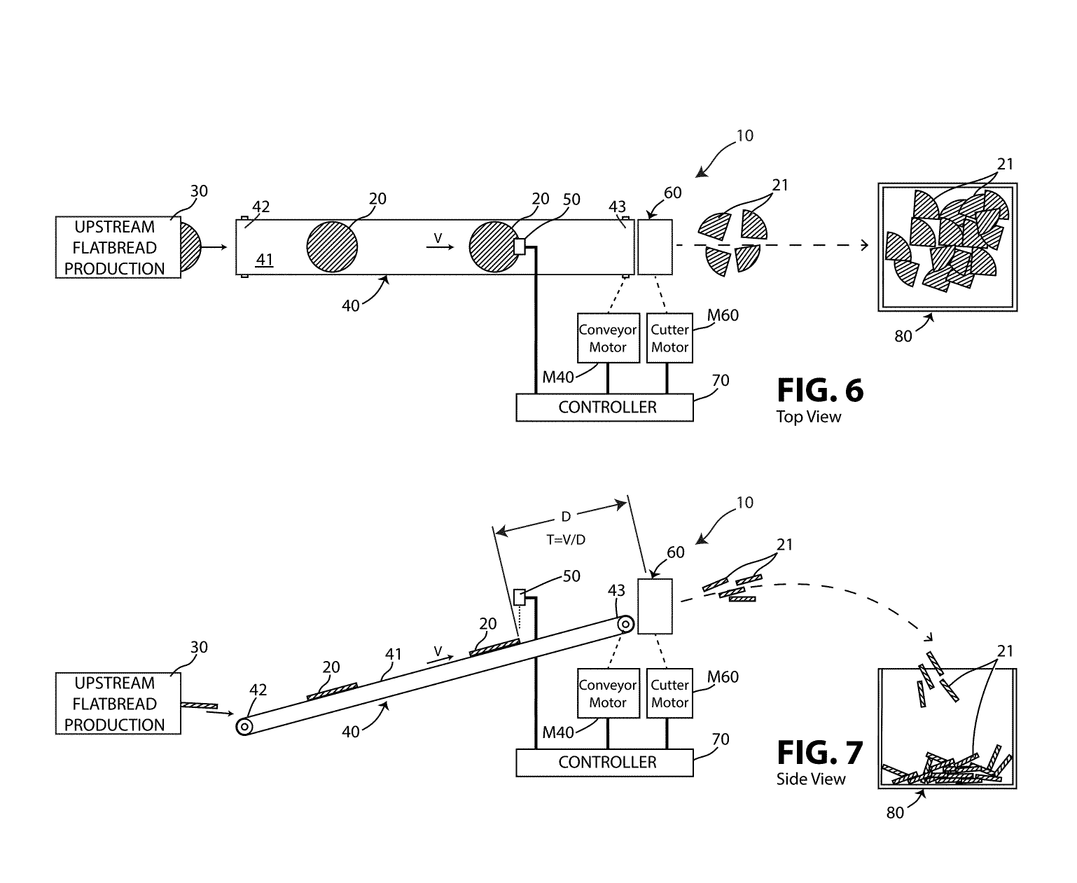

There are many possible embodiments of a Continuous Tortilla Chip Cutting System according to the present invention. FIGS. 6 and 7, for example, are schematic top and side views of a first preferred, albeit simplified embodiment of a Continuous Tortilla Chip Cutting System 10 for cutting tortillas 20 into pre-cuts 21. As shown in FIGS. 1 and 2, the system 10 receives the tortillas 20 from an upstream flatbread production line 30 which may be fully automated, manual, or some combination thereof. As shown, the system 10 comprises a conveyor 40 that is driven by a conveyor motor M40, a detector 50, a cutting mechanism 60 that is driven by a cutter motor M60, and a controller 70.

The goal is to form pre-cuts 21 that are distinct from one another, undamaged, and of consistent shape. The pre-cuts 21 formed by the system 10 are usually intended for frying, after further cooling or at some time in the future. For example, the producer may sell the box 80 of pre-cuts 21 to a restaurant, bar, or the like, who will fry a portion of the pre-cuts 21 on demand, in order to serve the retail customer with hot, fresh-fried, tortilla chips.

In the illustrated embodiment, the pre-cuts 21 are discharged directly into a box 80 (usually lined with plastic) for hypothetical sale to a customer of the producer, but it should be understood that it may be desirable to further cool the pre-cuts by transporting them on a cooling conveyor, or equivalent, before stacking and packaging them into a box 80.

In the preferred embodiment, as best shown in the side view of FIG. 7, the preferred cutting mechanism 60 accelerates the pre-cuts 21 upward, through an arc, so that they are discharged and tend to separate from one another. The preferred conveyor 40 has an upper surface 41 that moves upward at an angle, with its input end 42 lower than its output end 43, but other arrangement and orientations are possible for both the conveyor 40 and the cutting mechanism 60.

The cutting mechanism 60 of FIGS. 1 and 2 is illustrated as a black box that can take on any suitable construction or manner of operation that is consistent with the present invention. It can be roller-based, guillotine-like, etc., without departing from the presently intended scope of the embodiments encompassed by the invention.

In operation, the production line 30 delivers flat bread units 20 to the input end 42 of the conveyor and the conveyor 40, driven by the conveyor motor M40 under the control of the controller 70, transports the flat bread units 20 on its upper surface 41, from the input end 42 to the output end 43, at a known, controlled, velocity V. Along the way, as it moves at velocity V, the detector 50 detects the leading edge (or other suitable datum) of each flat bread unit 20 and outputs a detection signal 51 to the controller 70. At the output end 43, each successive flat bread unit 20 is fed to the cutting mechanism 60 that is driven by a cutter motor M60. The controller 70 controls the cutter motor M60, based on the detector 50's detection of the flat bread unit 20, the speed V, and the distance D, in order to actuate the cutting mechanism 60 at just the right time and at just the right speed in order to consistently, repeatedly cut each flat bread unit 20 into a substantially identical plurality of “pre-cuts” 21, flat bread unit after flat bread unit.

### Second Preferred Embodiment

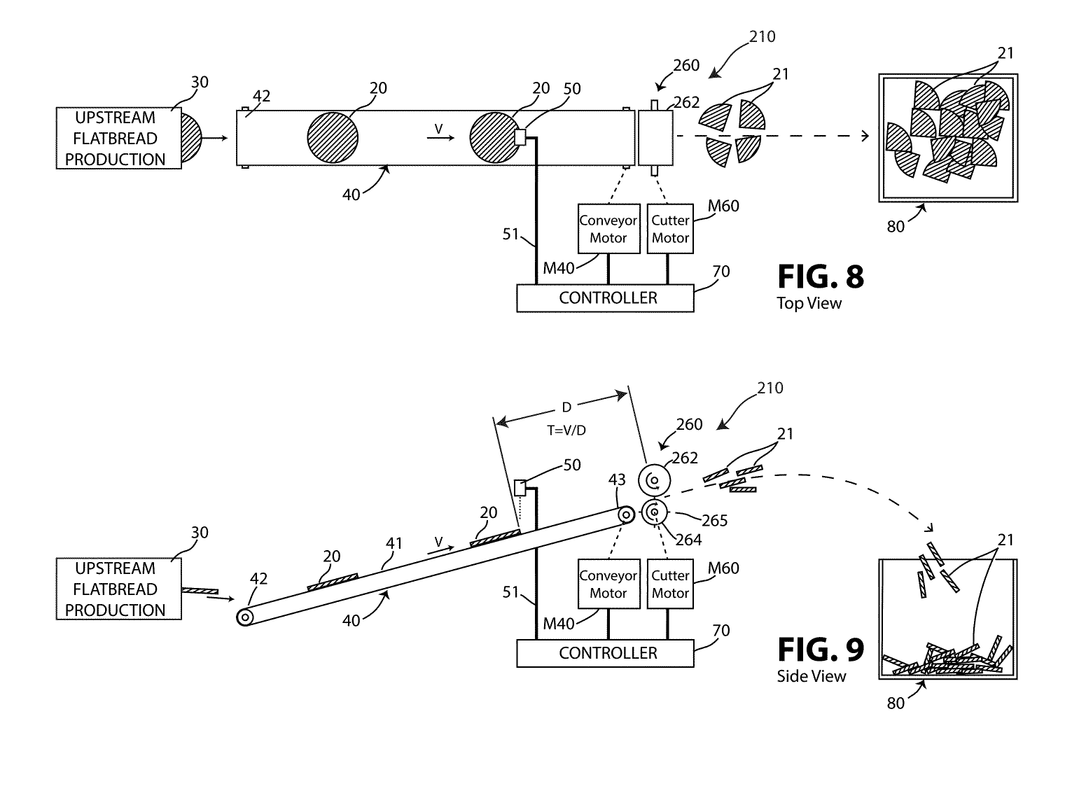

FIGS. 8 and 9 are schematic top and side views of a second preferred embodiment of a continuous flat bread cutting apparatus 210 that is similar to the first preferred apparatus 10, but more specifically comprises a cutting mechanism 260 that formed from a pair of counter-rotating rollers 262, 264. As suggested by FIG. 9, the preferred upper roller 262 has a substantially smooth surface for cutting against (made e.g. of UHMW polyethylene), and the lower roller 264 has a plurality of blades 265 that rotate against the upper roller 262 (made e.g. of stainless steel). The key to consistent operation is to have the cutter roller 264 in a known starting position prior to the detection of each subsequent flatbread unit 20, and then to start its rotation at just the right time to cut each flatbread units 20 into correctly shaped pre-cuts 21.

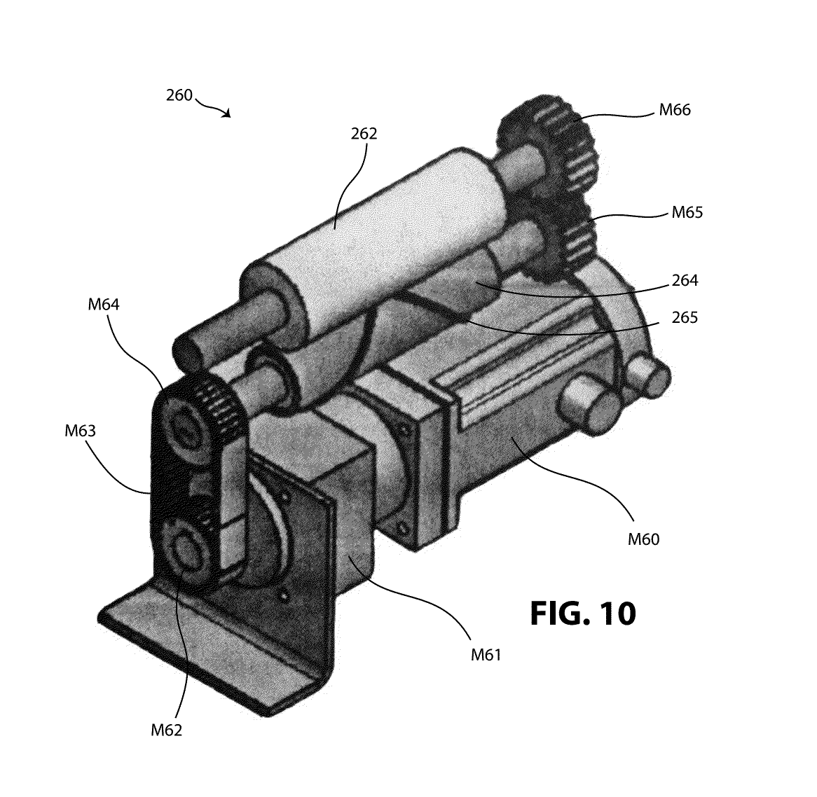

FIG. 10 is a perspective view of the cutting mechanism 260 used in the second preferred embodiment of FIGS. 8 and 9. As shown, the upper roller 262 and rotating die or cutter roller 264 are driven in a counter-rotating fashion through a mechanical arrangement comprised of a servo motor M60, a servo gear box M61, a sprocket M62, a belt M63, a driven gear M64 on one end of the cutter roller 264, a driving gear M65 on an opposite end of the cutter roller 264, and a driven gear M66 on the upper roller 262. In operation, the rotating die (or cutter) 264 captures each individual tortilla 20 and rotates its blades 265 through the tortilla, against the upper roller 262, cutting it into quarters, eighths, or whatever size a food producer desires.

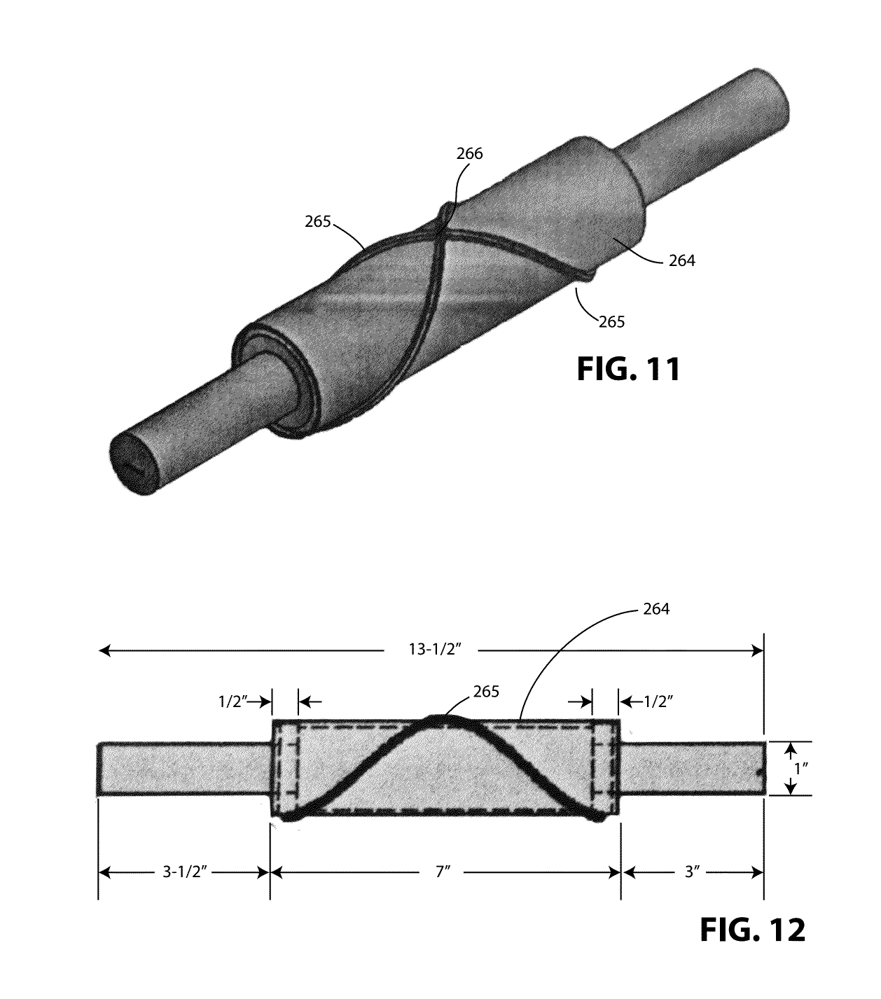

FIG. 11 is an isolated perspective view of the rotating die or cutter roller 264, showing how its blades 265 are arranged to form a pattern that will, in this particular case, divide a tortilla 20 into four triangular pre-cuts 21, as shown in FIG. 3. Note that the blades 265 cross over at a central portion 266. As already alluded to, the key is to time the rotation of the cutter roller 264 such that the central portion 266 is aligned with the center of the tortilla 20 as it passes through the cutting mechanism 260.

In the second preferred system 210, as with the others, this timing is accomplished by using a controller 70 that controls the velocity V of the conveyor belt 40 through a conveyor motor M40. Preferably, the conveyor motor M40 is controlled so as to drive the conveyor belt 40 at a rate of speed V that is higher than the previous conveyor (e.g. from a cooling conveyor) so that distance (physical space) is created between each of the tortillas 20.

As the tortillas 20 travel further on the upper surface 41 of the high-speed conveyor 40, it passes beneath a sensor 50 (e.g. a robotic eye, or light sensor, or other suitable sensor) that sends a detection signal 51 to the controller (or on-board computer) regarding the tortilla's presence and imminent arrival at the cutting mechanism 260. In operation, the length of time before the tortilla 20 reaches the cutting mechanism 264 is a function of the distance D and the velocity V, i.e. T=V/D. As a result of this arrangement, the controller 70 drives the cutting mechanism 160 at just the right time, when the tortilla 20 arrives, so that the cutting mechanism 160 ejects four substantially identical pre-cuts 21.

FIG. 12 is a dimensioned plan view of the cutter roller 264 showing its general construction in more detail and, based on the 7″ width of the central cylinder that supports the cutting blades 265, the fact that it is designed to cut 6″ diameter tortillas into pre-cuts 21. The presently preferred cutter roller 264 is formed by CNC milling a stainless steel cylinder to leave behind the cutting blades 265, but other methods of manufacture may be employed.

### Third Preferred Embodiment

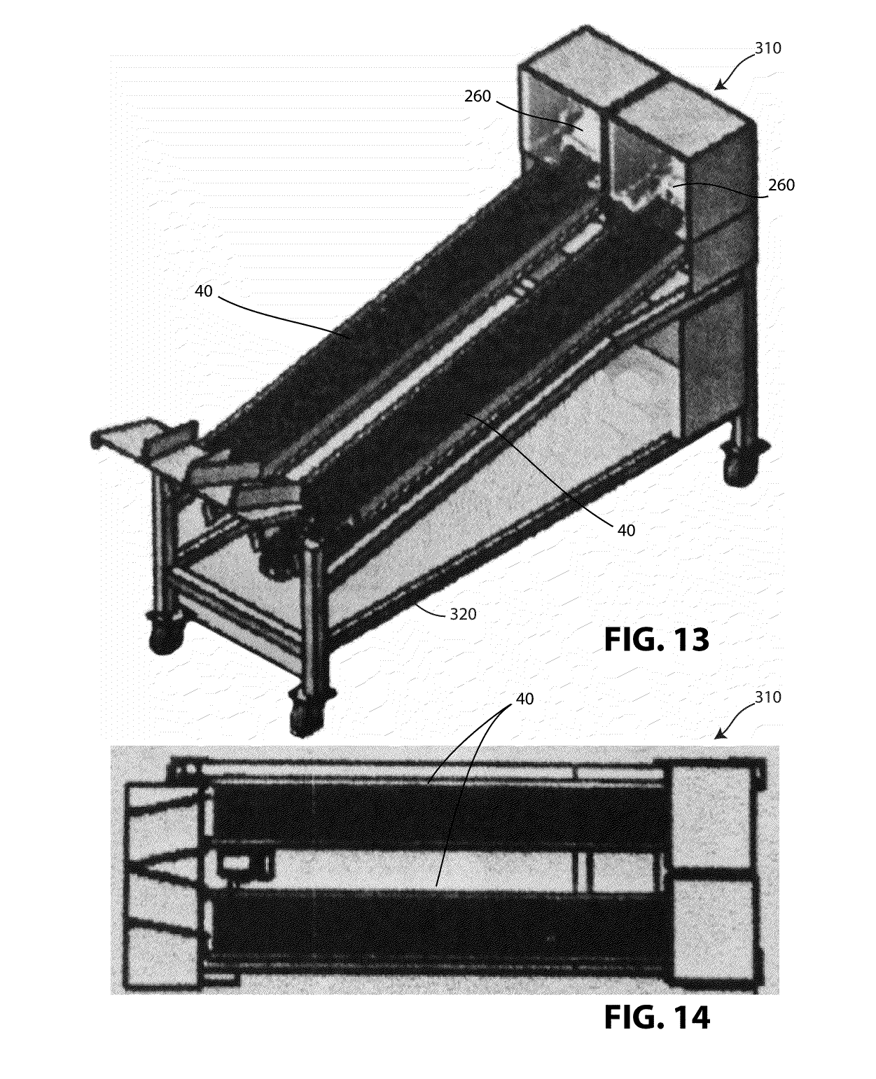

FIG. 13 is a perspective view of a third preferred embodiment that is like the second preferred embodiment, but comprises a suitable frame 320 that supports two parallel conveyor belts 40 and two corresponding cutting mechanisms 260 for providing increased throughput when fed by a two-row tortilla production line.

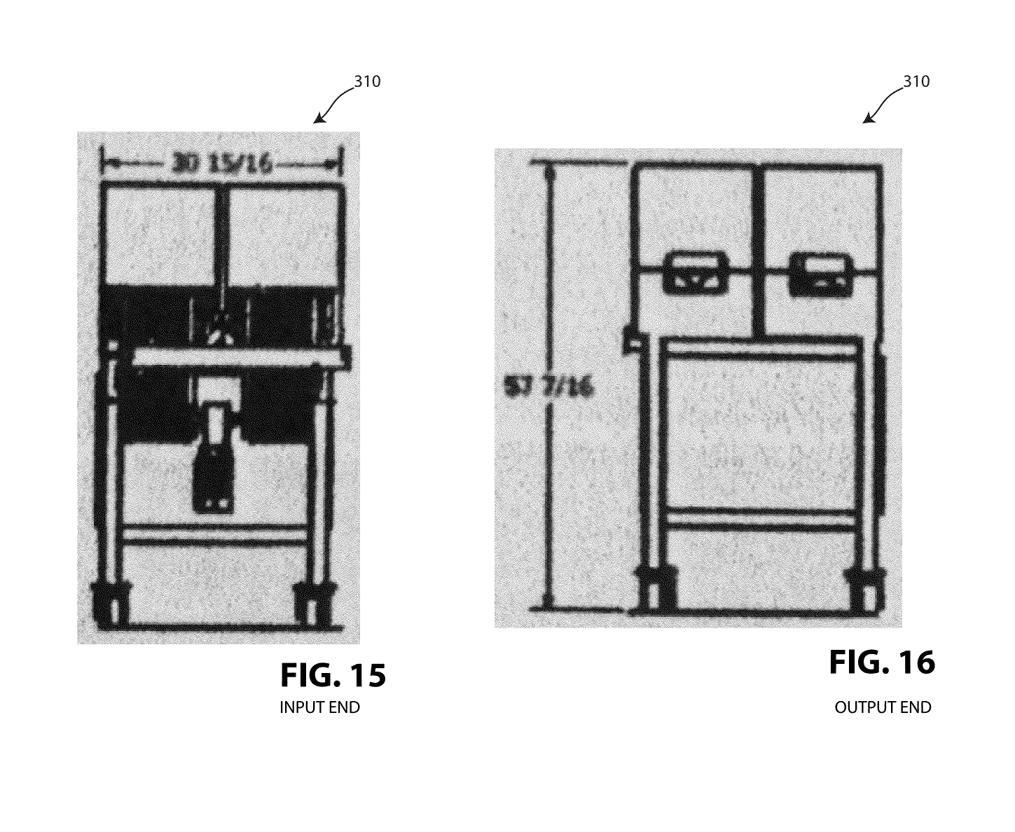

FIGS. 14 to 16 are top, input end, and output end views, respectively, of the third preferred embodiment of FIG. 13.

### Fourth Preferred Embodiment

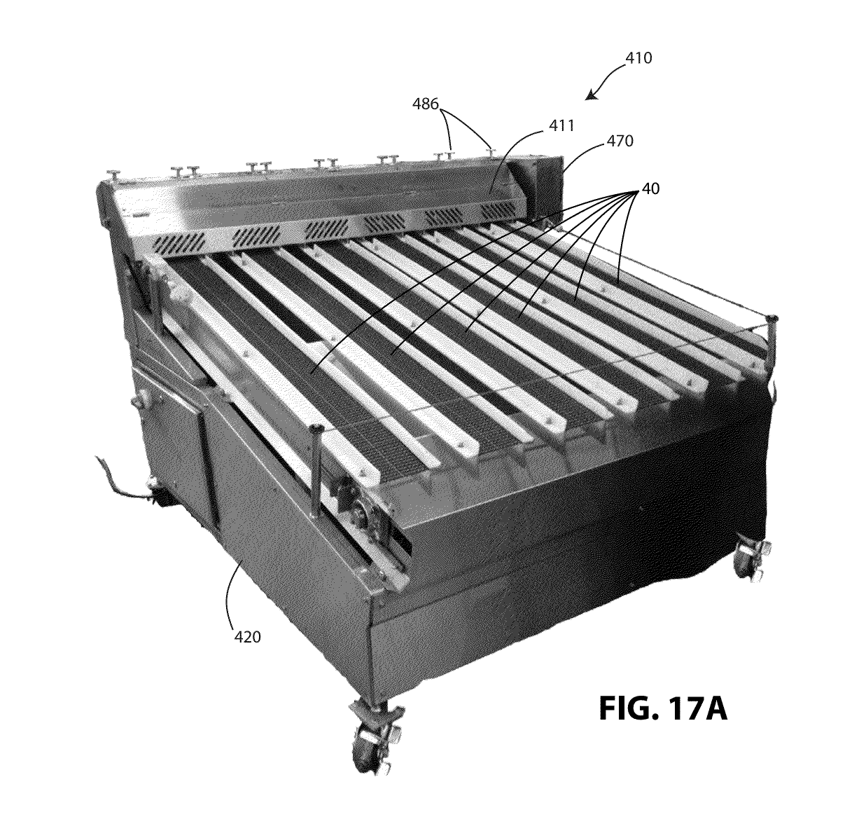

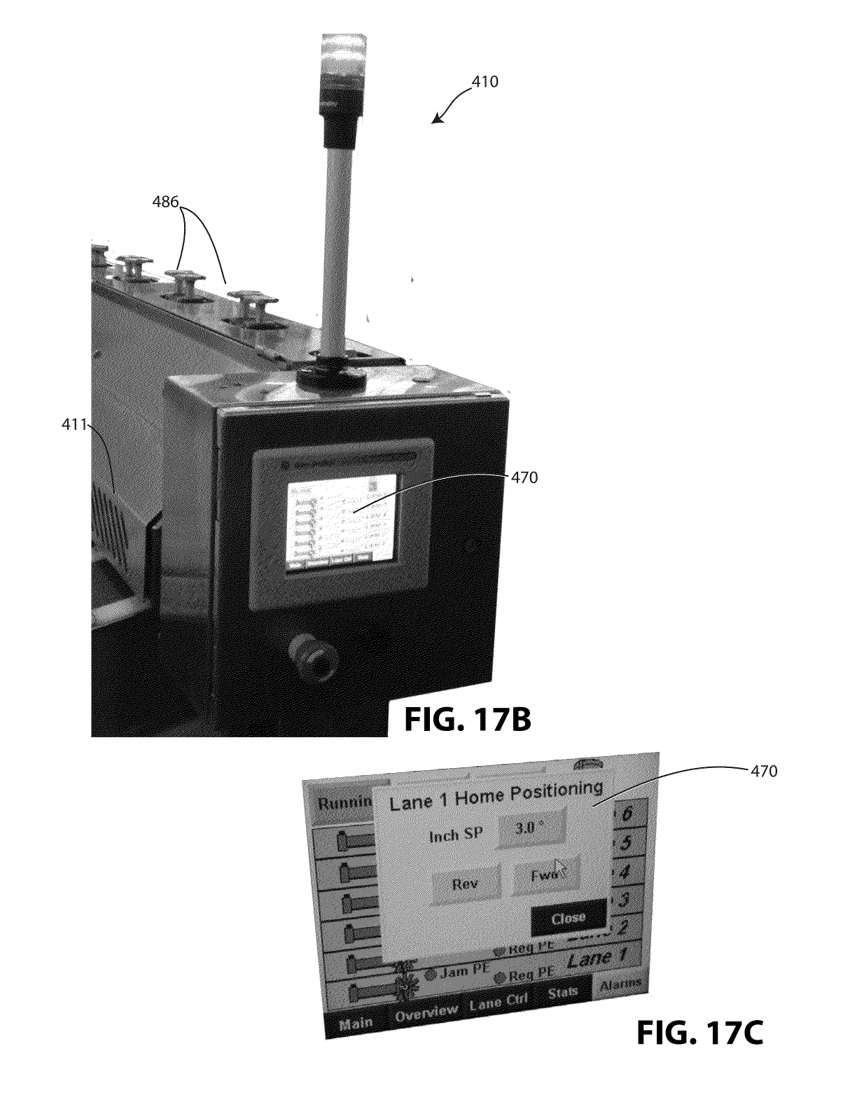

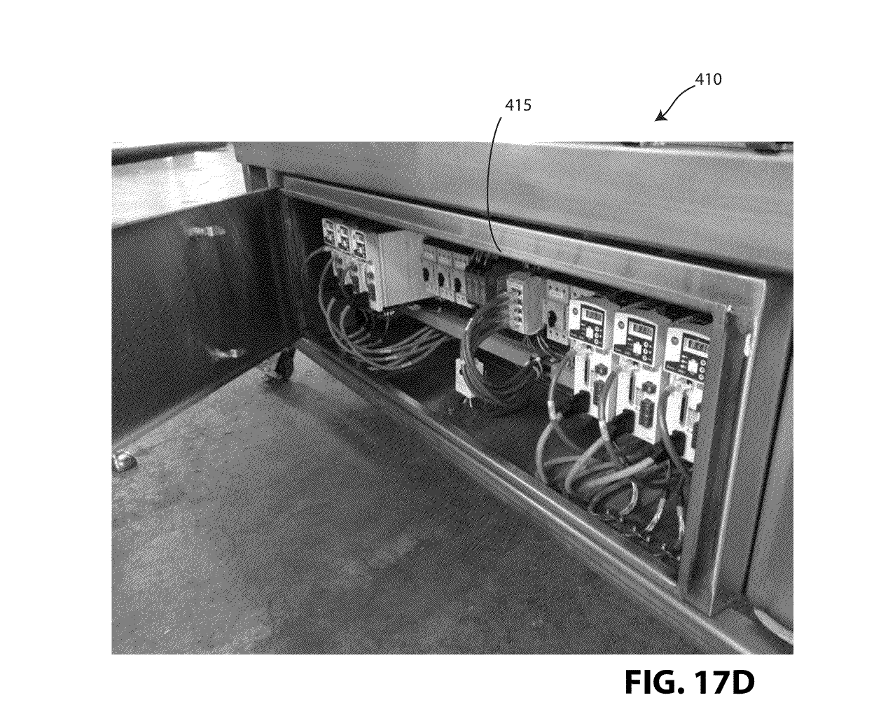

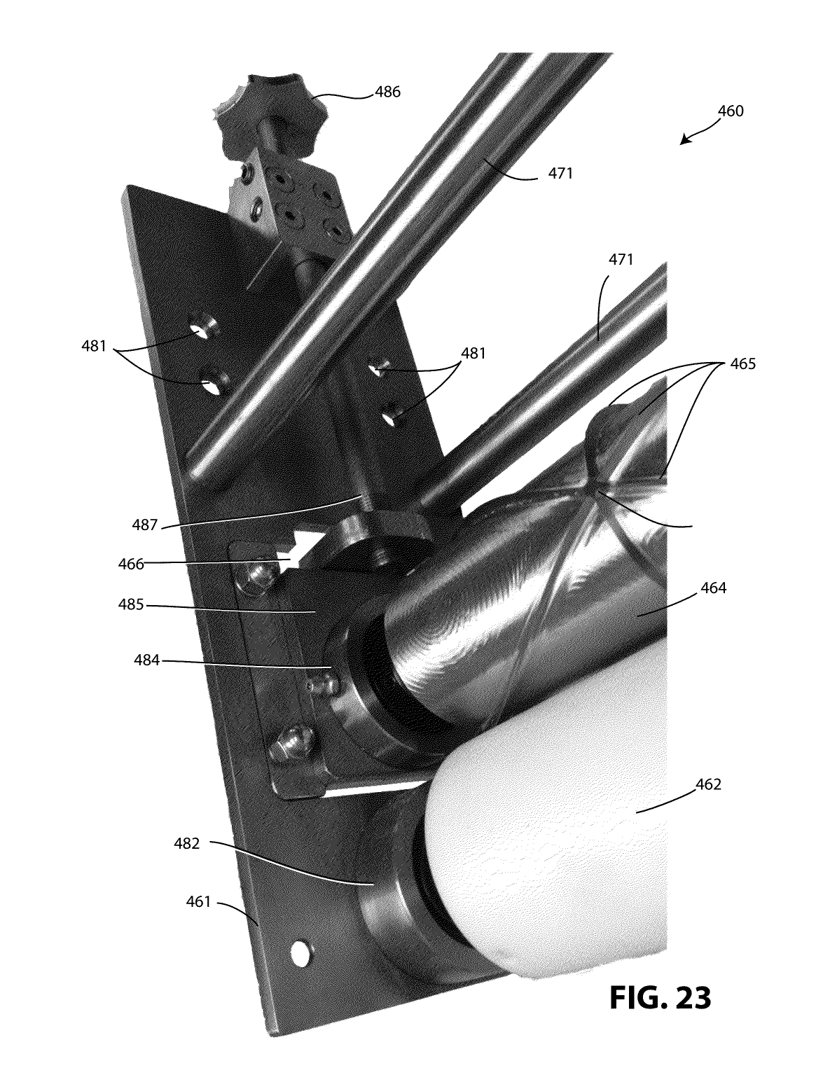

FIG. 17A is a perspective view of a fourth presently preferred continuous flat bread cutting system 410 that features a frame 420 carrying six independently driven conveyors 40 for receiving tortillas 20 discharged in a corresponding number of lanes at the output end of an upstream production system (e.g. from a cooling conveyor or the like). In this embodiment, the six conveyors 40 are slanted upward, as with the earlier embodiments, and they are driven by servo motors to rapidly transport tortillas 20 toward modular cutting mechanism cartridges 460 (described more fully below) that feature a pair of counter-rotating rollers like the cutting mechanism 160 mentioned above. A protective cover 411 is provided for safety purposes. A controller 470 is accessible via a control box mounted to the side of the system 410. Six pairs of adjustment handles 486, 486 are present, as explained further below with respect to FIG. 23.

FIG. 17B is a view of the graphical interface to the preferred controller 70, an Allen Bradley® Panel View Plus 600, a programmable unit that can accurately drive servo motors to control the velocity V of each conveyor belt 40 and then, based on the input of a detection signal from the optical detector 450, can accurately control the exact turn-on time and speed of the servo motors that run each corresponding cutting mechanism 460.

FIG. 17C is a screen used to adjust the home positioning that accurately and repeatedly positions the cutter roller 464 in the center of the tortilla 20. The inventors contemplate the use of servo motors that are self-homing in future embodiments.

FIG. 17D is a perspective view of the electrical box 415 on the lower exit side of the system 410 where one finds the six variable frequency motor drivers that, under the direction of a suitable program running on the controller 70, drive the six corresponding cutting mechanisms 460.

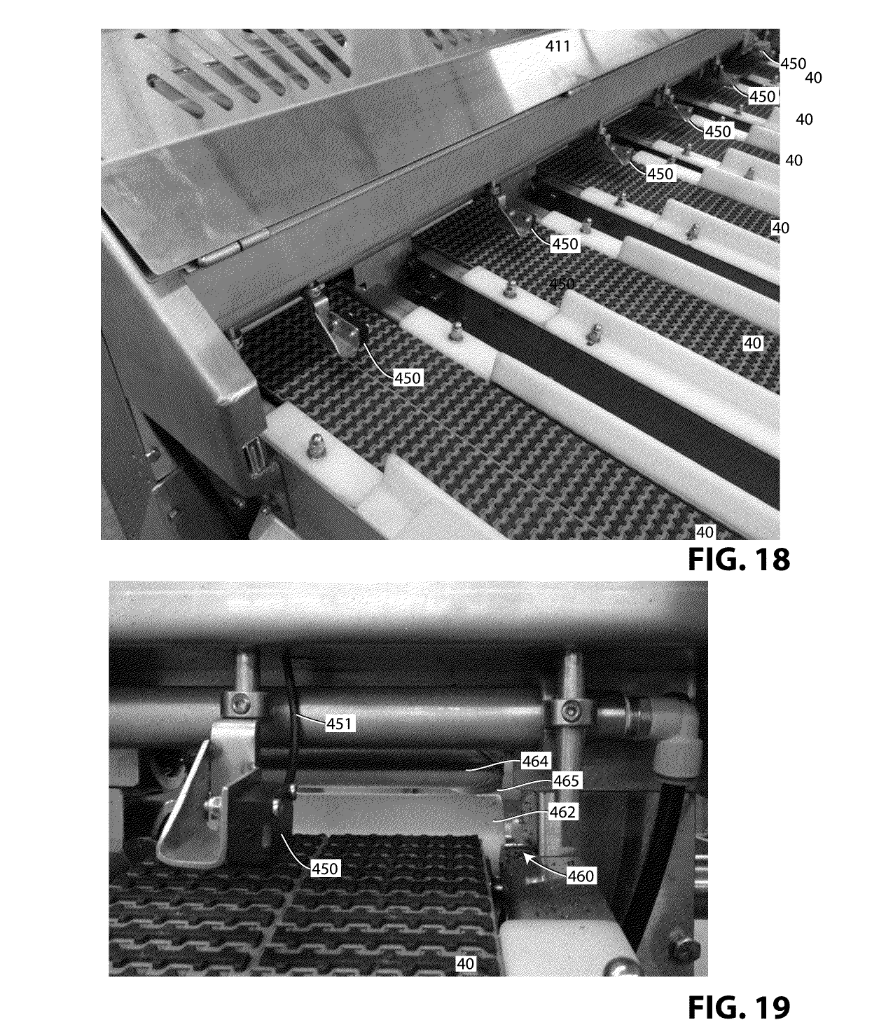

FIG. 18 is a close-up view of the output end of the six conveyors 40, with the protective cover 411 lifted open, to reveal six corresponding sensors 450 that detect the tortillas 20 that are being independently transported at high speed by each of the six conveyors 40.

FIG. 19 is a close-up view looking inward toward the sixth or right-most sensor 450 in FIG. 18, at the top of the sixth conveyor belt 40, and reveals the conductors 451 that transmit the sensor 450's detection signal to the controller 470. Looking closely, one can see the input to the associated cutting mechanism 460, including a substrate roller 462 made of UHMW, and a cutter roller 464 that is made of stainless steel and has had cutting blades 465 milled into its periphery.

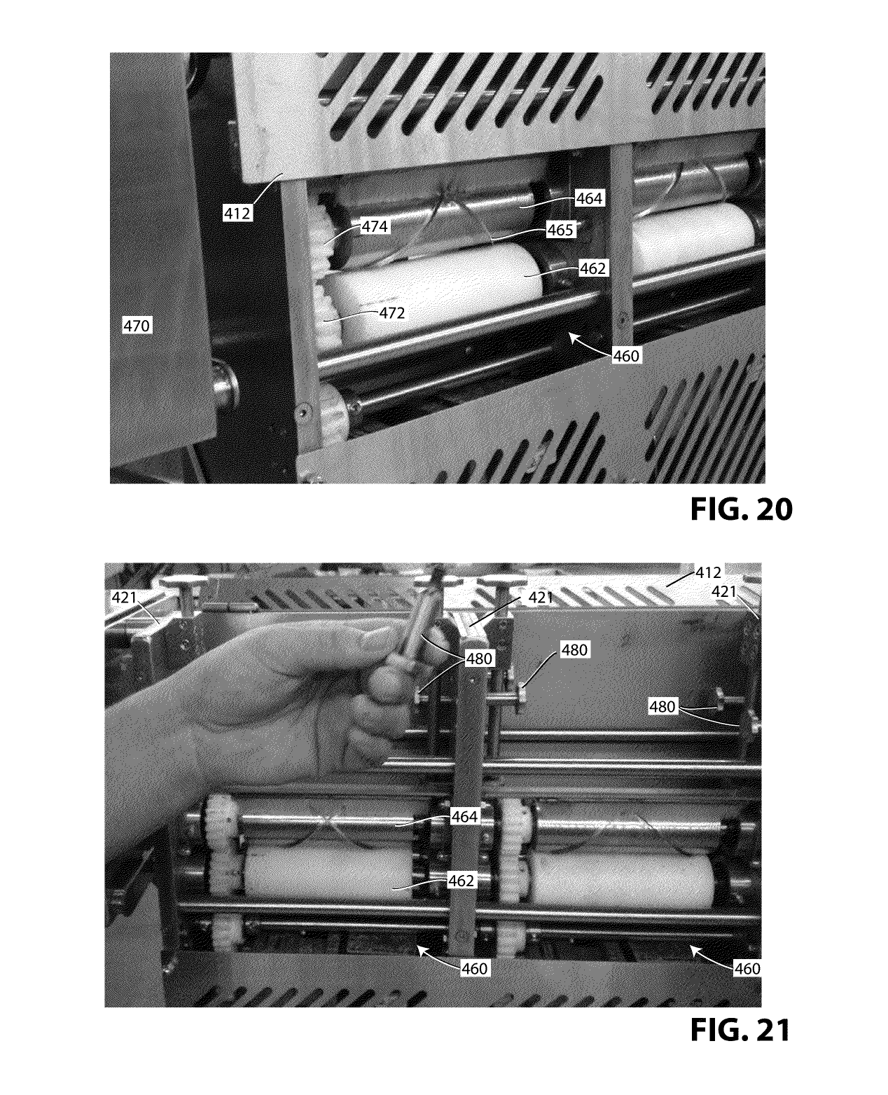

FIG. 20 is a close-up view of the output side of the same row, looking back in a direction opposite to that of FIG. 19. Another protective cover 412 is provided for safety purposes. As shown, the cutting mechanism 460's substrate roller 462 and cutter roller 464 are connected to one another by corresponding gears 472, 474. The construction of the cutting mechanism 450 will become clearer from further description.

FIG. 21 is a view of the output side of the system 410, like FIG. 20, but with the protective cover 412 rotated upward about its hinges in order to reveal more details. One can now begin to see the modularity of the cutting mechanisms 460. First, for purposes of modularity, the system frame 420 includes a number of vertical divider walls 421 (seven in total for six lanes) and, as suggested by the one hand bolt 480 that has been unscrewed from the divider wall 421 next to the right side of the left-most cutting mechanism 460, each cutting mechanism cartridge 460 is detachably secured, as desired, between an adjacent pair of vertical divider walls 421 by four hand bolts 480, two extending to the left and two extending to the right. By using modular cutting mechanism cartridges 460, it is a relatively simple matter to repair or replace any given cutting mechanism 460.

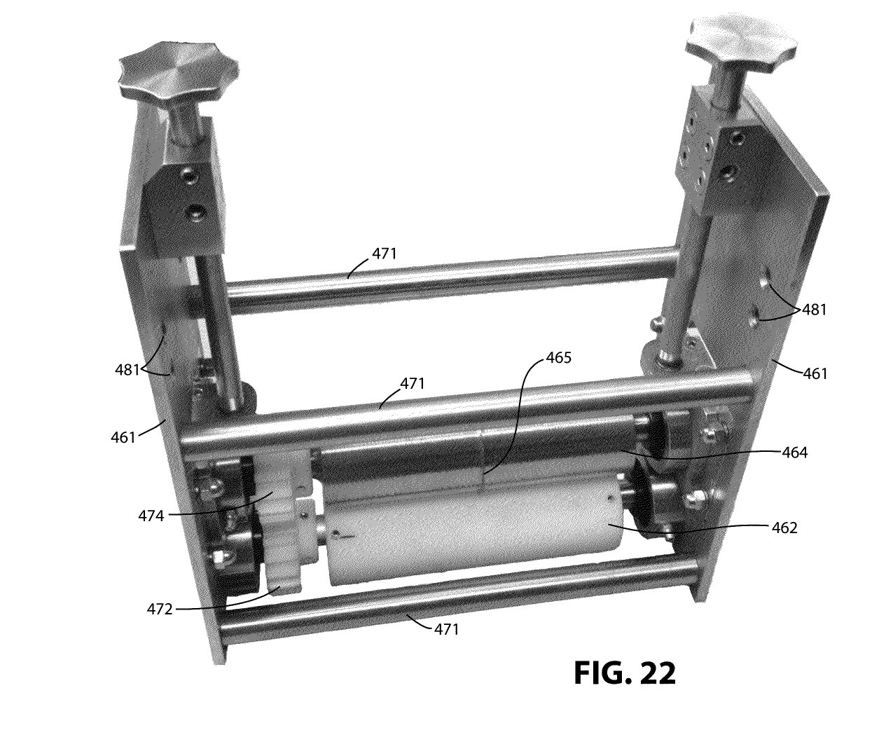

FIG. 22 is a perspective view of a modular cutting mechanism cartridge 460, shown in isolation for clarity of construction and overall operation. As shown, the cutting mechanism 460 comprises left and right side walls 461, 461 that, for rigidity, are braced to one another by four transverse connecting members 471. The backing roller 462 and cutter roller 464 are supported between the side walls, with their shafts supported by suitable bearings (described further below). The rollers 462, 464 are operatively connected to one another by gears 472, 474. Each side wall includes two pairs of holes 481 and, as best shown by FIG. 21, the hand bolts 480 extend through the holes 481 in order to secure the overall cutting mechanisms 460 to the divider walls 421 of the system's frame 420. Because the side walls 421 are relatively thin, each side plate 461 has two holes on one side and two holes on the other side, and there are corresponding holes in the dividing walls 421. That way, the threaded tips of two nearby hand bolts 480 that are threaded toward one another are vertically spaced and do not interfere.

FIG. 23 is a close-up view of the non-geared side the modular cutting mechanism 460 of FIG. 22, showing the bearings and positional adjustment mechanism. As shown, the backing roller 462 has a shaft (not visible) that rotates in a bearing 482 that is fixed to the side plate 461. The cutting roller 464, by contrast, has a shaft (also not visible) that rotates in a bearing 484 that is connected to a carrier 485 that slides within an aperture 466 in the side wall 461, and is vertically adjustable therein through the operation of a handle 486 (see FIG. 17) that turns a threaded adjustment rod 486 connected to the carrier 485. Through this arrangement, the operate can carefully adjust the cutter roller 464's proximity to the backing roller 462, making it close enough to provide quality cutting, but not in direct contact therewith in order to extend the life of the cutting blades 465.

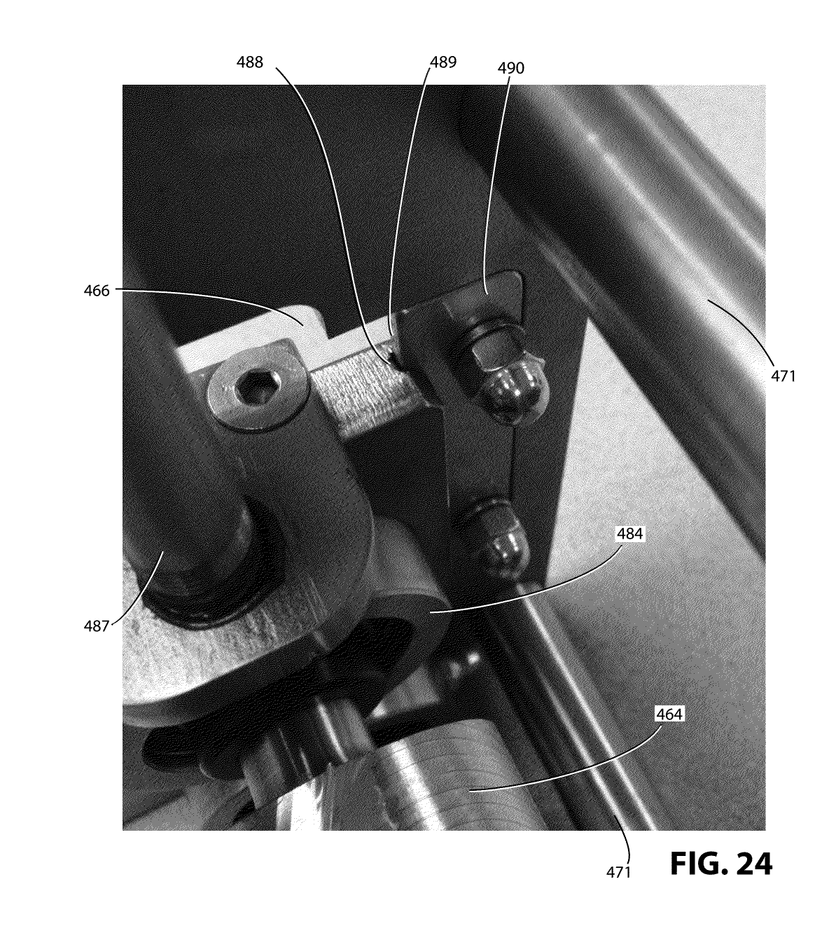

FIG. 24 is an even closer view of the interface between the aperture 466 in the side plate 461 and the carrier 485 that supports the bearings 484 that hold the cutter roller 464. As shown, the carrier 485 has notches 488 in its parallel sides (only one is shown in this view) and each notch 488 receive the edge 489 of a retention plate 490 that is bolted to the side plate 461. As a result, the carrier 485 is restrained within the aperture 466, but it can move vertically up and down along the edges 489 of the retention plates. Many other constructions are possible.

Improved Cutter Roller Blades

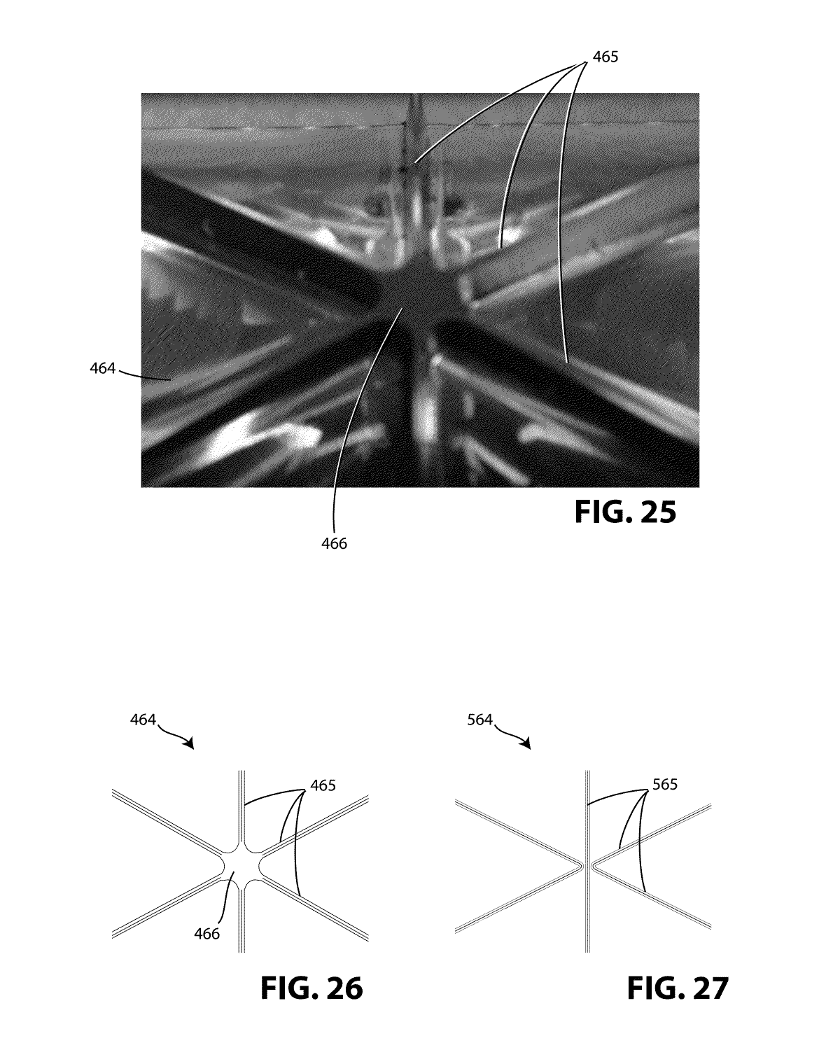

FIG. 25 is a close-up that is best understood by briefly returning briefly to FIG. 23 where one sees a cutter roller 464 that has been CNC-milled to provide three intersecting cutting blades 465 that, as shown in FIG. 4, will divide a tortilla 20 into six segments. FIG. 25 is a close-up of the three cutting blades 465 that intersect in a central portion 466. Due to manufacturing limitations associated with the CNC milling process (i.e. the finite size of the milling bit that removes material to leave behind the cutting blades 465), the center portion 466 takes on a star-shape of finite area. This phenomenon occurs even with a 4-chip pattern, but is most predominant with a pattern of 6-chips or more. As a result of this star shaped central portion 466, when the cutter roller 464 is used to cut each tortilla 20 into a number of pre-cuts 21, the central portion 466 will crush a corresponding area of the tortilla 20, rather than cleanly cut that area into one of the pre-cuts. As a result, the cutting mechanism 460 creates and debris and powder that builds up over time and must be cleaned. It is also possible that the pre-cuts 21 will have a slightly misshapen tip.

FIG. 26 is a schematic representation of the cutter roller 464 of FIGS. 23 and 24, including its cutting blades and central portion 466. FIG. 27 shows an improved cutter roller 564 where the cutting blades 565 are arranged to be close enough to cut the tortilla 20 into the desired pre-cuts 21 of triangular shape, but notably, do not intersect one another and form a dense central section as in FIG. 26.

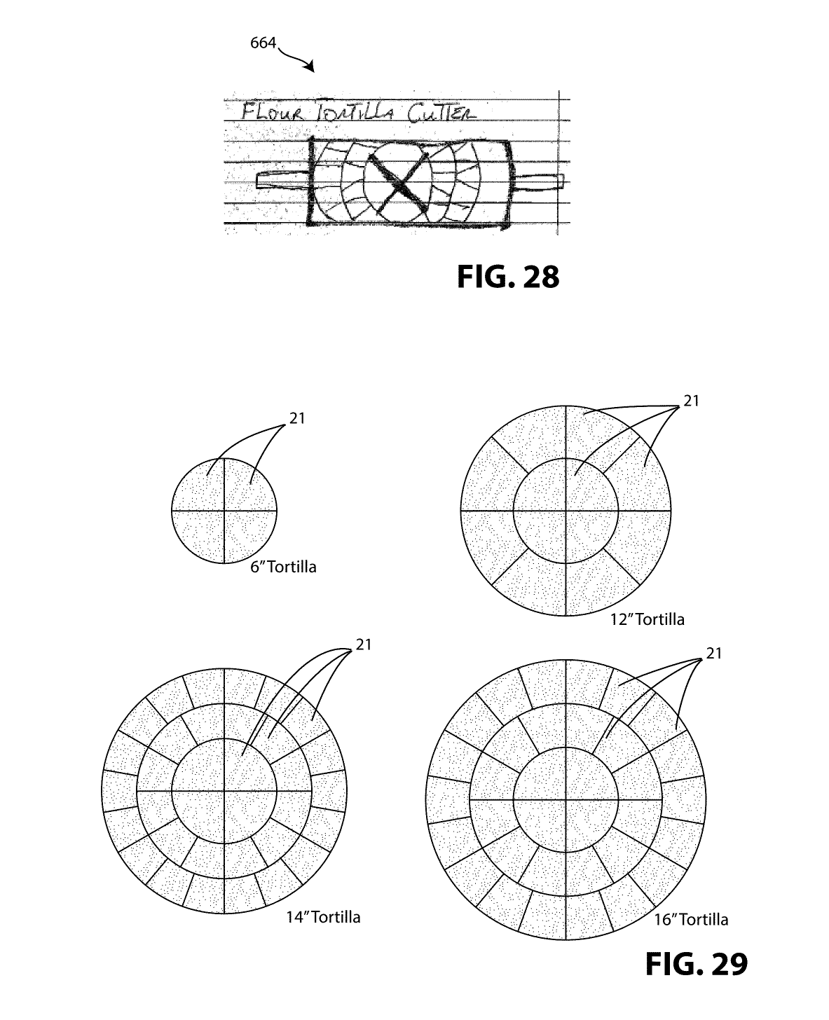

FIGS. 28 and 29 relate to alternative cutter roller 664 that uniquely cuts several similar shaped pre-cuts 21 from a larger tortilla, e.g. a 12″, 14″ or 16″ tortilla, for example, rather than from a smaller 6″ tortilla. As suggested by FIG. 29, the cutting pattern used with a larger tortilla can take on a variety of different configurations (e.g. concentric rings cut along radii of differing angular spacing) so that many more pre-cuts of similar shape can be provided by the larger tortillas. The result would be a more efficient and higher through-put production line.

The embodiments disclosed herein have largely focused on corn tortilla systems. However, the underlying concepts can be applied to other production systems that produce flatbread units such as flour tortillas, pita bread, etc.

We claim:

1. A continuous flat bread cutting apparatus for cutting flat bread units produced by a flat bread production line into multiple pieces (“pre-cuts”) for frying into chips, comprising:
a conveyor having an upper surface for carrying the flat bread units, the conveyor moving the flat bread units from an input end to an exit end thereof;
a detector that detects the flat bread units moving on the conveyor and outputs a detection signal;
a cutting mechanism that receives the flat bread units from the exit end of the conveyor, flat bread unit by flat bread unit, cuts each flat bread unit into a plurality of pre-cuts, and ejects the pre-cuts; and
a controller that, in response to the detection signal, causes the cutting mechanism to execute a cutting motion in sync with the moving of the flat bread units to consistently cut the flat bread units into substantially identical pre-cuts.

2. A continuous flat bread cutting apparatus for accurately and consistently cutting substantially round flat bread units into multiple sub-pieces of desired shape for later frying, one after another, the flat bread units being produced by a flat bread production line where the spacing between and relative location of each successive flat bread unit varies due to normal production-related movement of the flat bread units while they are being produced, the apparatus comprising:
a conveyor having an upper carrying surface that is adapted to receive a succession of flat bread units from the flat bread production line and move them onward for cutting;
a conveyor motor for driving the upper carrying surface of the conveyor and flat bread units carried thereby at a conveyor velocity;
a sensor for detecting that a flat bread unit moved by the conveyor is at a sensed position and outputting a sensor signal; and
a repetitive cutting mechanism that is located at a predetermined distance from the sensed position, the cutting mechanism having cutting blades that define a cutting pattern corresponding to the multiple sub-pieces;
wherein the repetitive cutting mechanism is adapted for being repetitively driven to cut each successive flat bread unit moved by the conveyor into multiple sub-pieces; and
wherein the repetitive cutting mechanism is individually synchronized with each successive flat bread unit moved by the conveyor so that the cutting blades accurately cut each flat bread unit into the multiple sub-pieces of desired shape, time after time, based on the conveyor velocity, the predetermined distance, and the sensor signal.

3. The continuous flat bread cutting apparatus of claim 2 further comprising:
a second motor for driving the repetitively cutting mechanism; and
a programmable controller for controlling the second motor to synchronously drive the repetitive cutting mechanism to so that its cutting blades accurately cut the flat bread unit into the multiple sub-pieces of desired shape.

4. The continuous flat bread cutting apparatus of claim 2 wherein the flat bread production line includes an output that ejects flat bread units onto the conveyor at an output velocity and wherein the conveyor velocity exceeds the output velocity to increase the spacing between successive ones of the flat bread units prior to reaching the repetitive cutting mechanism.

5. The continuous flat bread cutting apparatus of claim 4 wherein the output of the flat bread production line comprises a cooling conveyor.

6. The continuous flat bread cutting apparatus of claim 2 wherein the sensor for detecting that a flat bread unit moved by the conveyor is at a sensed position comprises an optical sensor.

7. The continuous flat bread cutting apparatus of claim 6 wherein the optical sensor comprises a photoelectric detector that illuminates the conveyor and detects the presence of a flat bread unit being moved by the conveyor based a difference between a reflectance of the conveyor and the flat bread unit.

8. The continuous flat bread cutting apparatus of claim 2 wherein the repetitive cutting mechanism comprises:
a base roller that rotates in a first direction and has a cylindrical body with a substantially smooth surface; and
a cutting roller that rotates in parallel with the cylindrical base roller in a second opposite direction to define an entry into a gap between the base and cutting rollers on one side thereof, the cutting roller having cutting blades that extend radially outward and rotate against the substantially smooth surface of the base roller,
the conveyor moving each successive flat bread unit into the gap between the base roller and the cutting roller, the cutting mechanism cutting each flat bread unit into the multiple sub-pieces between the base roller and cutting roller and then forcefully discharging the multiple sub-pieces out of an opposite side thereof to fully separate the multiple sub-pieces from one another.

9. The continuous flat bread cutting apparatus of claim 8 wherein the cylindrical base roller is formed from UHMW.

10. The continuous flat bread cutting apparatus of claim 8 the cylindrical cutting roller having cutting blades is formed from stainless steel.

11. The continuous flat bread cutting apparatus of claim 8 wherein the repetitive cutting mechanism is positioned so that the gap between the base and cutting rollers is spaced from a discharge end of the conveyor.

12. The continuous flat bread cutting apparatus of claim 8 wherein a rotation of the cutting roller is controlled so that the cutting blades of the cutting roller are synchronized with each successive flat bread unit moved by the conveyor to make the cutting blades accurately cut the flat bread unit into the multiple sub-pieces of desired shape, based on the conveyor velocity, the predetermined distance, and the sensor signal.

13. The continuous flat bread cutting apparatus of claim 2 wherein the repetitive cutting mechanism is located at or near a discharge end of the conveyor.

14. The continuous flat bread cutting apparatus of claim 2 wherein the substantially round flat bread units are one of corn tortillas and pita bread.

15. The continuous flat bread cutting apparatus of claim 8 wherein the desired shape is substantially triangular and wherein the cutting blades of the cutting mechanism define a cutting pattern that cuts each substantially round flat bread unit into a plurality of sub-pieces that are substantially triangular.

16. The continuous flat bread cutting apparatus of claim 15 wherein the cutting blades comprise four blade segments that radiate outward from a central point and cut each substantially round flat bread unit into four sub-pieces that are substantially triangular.

17. The continuous flat bread cutting apparatus of claim 15 wherein the cutting blades comprise six blade segments that radiate outward from a central point and cut each substantially round flat bread unit into six sub-pieces that are substantially triangular.

18. The continuous flat bread cutting apparatus of claim 8 wherein the desired shape is substantially rectangular and wherein the cutting blades of the cutting mechanism define a cutting pattern that cuts each substantially round flat bread unit into a plurality of sub-pieces that are substantially rectangular.

19. The continuous flat bread cutting apparatus of claim 18 wherein the cutting blades comprise a plurality of parallel blade segments that cut each substantially round flat bread unit into a plurality of sub-pieces that are substantially shaped as thin rectangular strips.

20. The continuous flat bread cutting apparatus of claim 18 wherein the cutting blades comprise a central blade that wraps around a central area of the cutting roller and a plurality of parallel blade segments that extend across the cutting roller in parallel with one another and perpendicular to the central blade to cut each substantially round flat bread unit into a plurality of sub-pieces that are substantially shaped as rectangular strips.

21. The continuous flat bread cutting apparatus of claim 2 wherein the conveyor motor comprises a variable speed motor and further comprising a variable frequency drive.

22. The continuous flat bread cutting apparatus of claim 2 wherein the apparatus includes multiple lanes.
